(19) United States
(12) Patent Application Publication
(10) Pub. No.: US 2021/0323060 A1
(43) Pub. Date: Oct. 21, 2021

(54) COPPER-SILVER COMPOSITE MATERIAL

(71) Applicants: CENTRE NATIONAL DE LA RECHERCHE SCIENTIFIQUE, PARIS (FR); UNIVERSITE TOULOUSE III - Paul Sabatier, Toulouse Cedex 9 (FR)

(72) Inventors: Florence LECOUTURIER, BALMA (FR); Christophe LAURENT, MONTGISCARD (FR); David MESGUICH, TOULOUSE (FR); Antoine LONJON, TOULOUSE (FR); Simon TARDIEU, CUSSET (FR); Nelson FERREIRA, VILLENEUVE TOLOSANE (FR); Geoffroy CHEVALLIER, AUZEVILLE-TOLOSANE (FR); Claude ESTOURNES, RIEUMES (FR)

(21) Appl. No.: 17/263,199

(22) PCT Filed: Jul. 25, 2019
(86) PCT No.: PCT/EP2019/069990

§ 371 Date: Jan. 26, 2021

(30) Foreign Application Priority Data
Jul. 27, 2018 (FR) 18 57040

(51) Int. Cl. B22F 3/16; B22F 3/105; B22F 5/12; B22F 9/24

(52) U.S. Cl. CPC B22F 3/162; B22F 3/105; B22F 5/12; H01B 1/026; B22F 2301/10; B22F 2301/255; B22F 2304/10; B22F 9/24

(57) ABSTRACT

The invention relates to a solid composite material comprising copper and an amount by volume of silver of less than about 5% by volume, relative to the total volume of said material, a process for manufacturing said material, and the uses of said material in various applications.

The invention relates to a solid composite material comprising copper and an amount by volume of silver of less than about 5% by volume, relative to the total volume of said material, a process for manufacturing said material, and the uses of said material in various applications.

The invention applies typically, but not exclusively, to the fields of microelectronics, industrial electromagnetic forming, conductors for power and/or telecommunications cables, and conductors for pulsed magnets. More particularly, the invention relates to a composite material having both good mechanical properties, notably in terms of tensile strength, and good electrical properties, notably electrical conduction properties.

Pure copper has excellent electrical conductivity (100% IACS or International Annealed Copper Standard), but has a low tensile strength, notably of about 200-400 MPa. Thus, mechanically-reinforced copper conductors have been proposed that comprise grains of pure copper in the form of nanocrystals or nanograins, or grains formed of a copper alloy. For example, Sakai et al. have described [Acta Materialia, 1997, 45, 3, 1017-1023] a copper-silver alloy comprising 24% by weight of silver, having an optimized tensile strength of about 1.5 GPa. However, its electrical conductivity is about 65% IACS. This conductivity does not make it possible to use the alloy in pulsed magnets which would then undergo a drastic increase in temperature, and/or in high-voltage power cables. The alloy is obtained by a process comprising the melting of a mixture comprising copper and silver, the casting of the mixture in a mould, then steps of cold drawing alternated with steps of heat treatment (notably at 330-430° C.). The process is energy-consuming and/or expensive since it requires numerous heat treatment steps.

Other solutions have been proposed, such as the manufacture of a copper-silver composite material. In particular, CN 102723144 B describes a copper-silver composite material comprising 24% by weight of silver, and having an acceptable tensile strength of around 970 MPa. However, here too its electrical conductivity remains very moderate (around 72% IACS). The composite material is obtained by a process comprising a step of inserting a silver bar into a copper tube, a step of vacuum electron beam welding, a step of heat treatment at 500-700° C., an extrusion step, followed by several steps of drawing, annealing, and shaping in order to form a composite monofilament. Several composite monofilaments (e.g. 630 monofilaments) are formed with the 5 aforementioned process, then inserted into a copper tube in order to repeat the aforementioned process. The process is very long, energy-consuming and/or expensive since it requires numerous heat-treatment and shaping steps.

Thus, the materials of the prior art have improved mechanical properties, at the expense of the electrical conductivity. Specifically, the methods of the prior art introduce internal defects such as grain boundaries, or stacking defects, which lead to a reduction in the electrical conductivity of the material obtained. Furthermore, the processes are often long and/or expensive.

Thus, the objective of the present invention is to overcome all or some of the drawbacks of the prior art and in particular to provide a composite material based on copper and silver, having improved electrical properties, in particular in terms of electrical conductivity, while guaranteeing good mechanical properties, in particular in terms of tensile strength, it being possible for said material to have performance levels suitable for use in the field of cables, notably as an electrically conductive element of a power and/or telecommunications cable, in the field of pulsed magnets, in the field of intense magnetic field installations and/or in the field of industrial electromagnetic forming. Another objective of the invention is to provide a simple and economical process for preparing such a material.

A first subject of the invention is therefore a material comprising copper and silver, characterized in that it is a solid composite material and in that it comprises an amount by volume of silver of less than about 5% by volume, relative to the total volume of said material.

The material of the invention has improved electrical properties, in particular in terms of electrical conductivity, while guaranteeing good mechanical properties, in particular in terms of tensile strength. In particular, it may have a conductivity of greater than or equal to about 75% IACS while guaranteeing a tensile strength of at least about 900 MPa.

In the composite material of the invention, the copper and silver are preferably in the form of grains having at least one of their dimensions of submicron size (i.e. less than 1 μm).

According to one embodiment of the invention, the copper (respectively the silver) is in the form of grains having at least one of their dimensions less than or equal to about 700 nm, preferably less than or equal to about 500 nm, more preferably ranging from about 50 to 400 nm, and more preferably ranging from about 100 to 300 nm.

Such grain dimensions make it possible to guarantee good electrical properties and good mechanical properties.

Considering several grains of copper (respectively of silver) according to the invention, the term “dimension” means the number-average dimension of the set of grains of a given population, this dimension being conventionally determined by methods well known to a person skilled in the art.

The dimension of the grain(s) according to the invention may be for example determined by microscopy, notably by scanning electron microscope (SEM) or by transmission electron microscope (TEM).

The material of the invention is a composite material. In the invention, the expression “composite material” means a material comprising at least one pure copper phase and at least one pure silver phase. In other words, said material is an assembly of at least copper grains and silver grains, the copper grains and the silver grains not being mutually soluble. It should be noted that a copper-silver composite material differs from a copper-silver alloy in which the copper is combined with the silver, for example by fusion or by mechanofusion. In particular, copper-silver alloys consist of a eutectic structure with two phases in the form of copper-silver solid solutions, one rich in copper, and the other rich in silver. The composite material of the invention does not comprise a zone of mutual solubility of the copper and of the silver. The absence of a zone of mutual solubility of the copper and of the silver in the composite material of the invention may notably be demonstrated by energy dispersive analysis (EDX).

The material of the invention is solid. In other words, it is in the form of a solid mass, or it is different from a material in the form of a powder or in the form of a pulverulent material.

The material of the invention preferably has a conductivity of at least about 80% IACS, more preferably of at least about 85% IACS, and more preferably of at least about 90% IACS, notably at 20° C.

The material of the invention preferably has an electrical resistivity of at most about 2.15 μΩcm, more preferably of at most about 2.03 μΩ.cm, and more preferably of at most about 1.91 μΩ.cm, notably at 20° C.

The material of the invention preferably has an electrical resistivity of at most about 0.70 μΩ.cm, more preferably of at most about 0.60 μΩ.cm, and more preferably of at most about 0.50 μΩ.cm, notably at −196° C.

The electrical resistivity is preferably determined using a device sold under the trade name KEITHLEY 2450 Sourcemeter, by the company TEKTRONIX.

The material of the invention preferably has a tensile strength of at least 900 MPa, preferably of at least 1 GPa, preferably of at least about 1.05 GPa, more preferably of at least about 1.1 GPa, and more preferably of at least about 1.2 GPa, notably at −196° C.

The tensile strength is preferably determined using a device sold under the trade name INSTRON 1195, by the company INSTRON.

The material of the invention preferably has an elongation at break of at least about 0.5%, notably at ambient temperature (i.e. 18-25° C.).

The elongation at break is preferably determined using a device sold under the trade name Epsilon 3442 extensometer, by the company DOERLER Mesures.

The material comprises silver in a proportion by volume of less than about 5%, relative to the total volume of said material. The low proportion of silver in said material makes it possible to guarantee a homogeneous material, in which the silver grains are uniformly dispersed within the copper grains. Indeed, at 5% by volume or above, the dispersion of the silver in the material is heterogeneous (e.g. presence of clusters), leading to a weakening of its mechanical properties.

According to a preferred embodiment of the invention, the material comprises at most about 2% by volume of silver, preferentially at most about 1.5% by volume of silver, and even more preferentially at most about 1% by volume of silver, relative to the total volume of said material.

The material of the invention generally comprises at least about 0.1% by volume of silver, and preferably at least 0.5% by volume of silver, relative to the total volume of said material.

The material of the invention may comprise at least about 98% by volume of copper, and preferably at least 99% by volume of copper, relative to the total volume of said material.

The material of the invention may comprise at most about 99.9% by volume of copper, and preferably at most 99.5% by volume of copper, relative to the total volume of said material.

In one particular embodiment, the material comprises at most about 0.5% by volume of unavoidable impurities, preferably at most 0.3% by volume of unavoidable impurities, and more preferably at most about 0.1% by volume of unavoidable impurities, relative to the total volume of said material.

The unavoidable impurities may be chosen from the elements Al, C, Fe, Ni, Pb, Si, Sn, Zn, Se, and a mixture thereof.

In one particular embodiment, the material comprises at most about 0.5% by volume, and preferably at most about 0.1% by volume, of other impurities chosen from O, S, P, Se, and a mixture thereof.

According to one embodiment of the invention, the material comprises only copper, silver and optionally unavoidable impurities and/or other impurities 30 as defined in the invention.

In a preferred embodiment of the invention, the material comprises essentially copper and silver. In other words, the copper and silver represent at least about 99.9% by volume, and more preferably about 100% by volume, relative to the total volume of said material.

The copper and/or the silver may be in the form of grains having a filament form.

The material of the invention is preferably anisotropic. In other words, it is composed of grains of copper (respectively of silver) elongated along a preferential direction, also referred to as grains of filament form.

Copper grains having a filament form are grains for example having:

a length (L_{Cu}), extending along a main direction of elongation,

two dimensions (D_{Cu1}) and (D_{Cu2}), referred to as orthogonal dimensions, extending along two transverse directions that are orthogonal to one another and that are orthogonal to said main direction of elongation, said orthogonal dimensions (D_{Cu1}, D_{Cu2}) being smaller than said length (L_{Cu}) and less than or equal to 700 nm, preferably less than or equal to about 500 nm, more preferably ranging from about 50 to 400 nm, and more preferably from about 100 to 300 nm, and

two ratios (F_{Cu1}) and (F_{Cu2}), referred to as shape factors, between said length (L_{Cu}) and each of the two orthogonal dimensions (D_{Cu1}) and (D_{Cu2}), said shape factors (F_{Cu1}, F_{Cu2}) being greater than 50, preferably greater than or equal to about 75, more preferably ranging from about 100 to 400, and more preferably from about 100 to 300.

According to one particular embodiment, the two orthogonal dimensions (D_{C1}, D_{Cu2}) of a grain having a filament form are equivalent or similar. Reference is then made to a “stick” or “wire”.

According to another particular embodiment, a grain having a filament form may be a “tape” in which the two orthogonal dimensions (D_{Cu1}, D_{Cu2}) of the grain according to the invention are its width (I_{Cu}) (first orthogonal dimension) and its thickness (E_{Cu}) (second orthogonal dimension), the width (I_{Cu}) notably being much larger than the thickness (E_{Cu}).

The length (L_{Cu}) of the grains of copper (respectively of silver) may be of micrometric size (i.e. less than 1 mm), preferably less than or equal to about 500 μm, preferably less than or equal to about 200 μm, more preferably ranging from about 1 to 150 μm and more preferably ranging from about 10 to 70 μm.

Silver grains having a filament form are grains for example having:

a length (L_{Ag}), extending along a main direction of elongation,

two dimensions (D_{Ag1}) and (D_{Ag2}), referred to as orthogonal dimensions, extending along two transverse directions that are orthogonal to one another and that are orthogonal to said main direction of elongation, said orthogonal dimensions (D_{Ag1}, D_{Ag2}) being smaller than said length (L_{Ag}) and less than or equal to 700 nm, preferably less than or equal to about 500 nm, more preferably ranging from about 50 to 400 nm, and more preferably from about 100 to 300 nm, and

two ratios (F_{Ag1}) and (F_{Ag2}), referred to as shape factors, between said length (L_{Ag}) and each of the two orthogonal dimensions (D_{Ag1}) and (D_{Ag2}), said shape factors (F_{Ag1}, F_{Ag2}) being greater than 50, preferably greater than or equal to 75, more preferably ranging from about 100 to 400, and more preferably from about 100 to 300.

According to one particular embodiment, the two orthogonal dimensions (D_{Ag1}, D_{Ag2}) of a grain having a filament form are equivalent or similar. Reference is then made to a “stick” or “wire”.

According to another particular embodiment, a grain having a filament form may be a “tape” in which the two orthogonal dimensions (D_{Ag1}, D_{Ag2}) of the grain according to the invention are its width (I_{Ag}) (first orthogonal dimension) and its thickness (E_{Ag}) (second orthogonal dimension), the width (I_{Ag}) notably being much larger than the thickness (E_{Ag}).

The length (L_{Ag}) of the silver grains may be of micrometric size (i.e. less than 1 mm), preferably less than or equal to about 500 μm, preferably less than or equal to about 200 μm, more preferably ranging from about 1 to 150 μm and more preferably ranging from about 10 to 70 μm.

The material of the invention preferably has a relative density of at least about 99%, and preferably of at least about 99.5%.

In the invention, the relative density is determined by the Archimedes method at 20° C., the reference body being pure water at 4° C.

The material of the invention may be in the form of a wire, notably having a diameter ranging from about 0.1 to 4 mm, preferably from about 0.2 to 1 mm, and more preferably from about 0.25 to 0.8 mm.

A second subject of the invention is a process for preparing a solid composite material in accordance with the first subject of the invention, characterized in that it comprises at least the following steps:

i) a step of dispersing micrometric copper particles and micrometric or submicrometric silver particles, in a non-solvent medium,

ii) a drying step in order to form a composite powder comprising said copper and silver particles, said powder comprising an amount of less than about 5% by volume of silver particles, relative to the total volume of said powder,

iii) a step of flash sintering at a temperature of at most about 600° C., in order to obtain a composite solid mass, and

iv) at least one cold-drawing step, in order to shape the composite solid mass from step iii).

Thus the process of the invention is simple and it makes it possible to obtain, in few steps, a composite material in accordance with the first subject of the invention, having improved electrical properties, in particular in terms of electrical conductivity, while guaranteeing good mechanical properties, in particular in terms of tensile strength. Furthermore, it avoids repeated annealing and/or heat-treatment steps as carried out in the processes of the prior art, while avoiding the phenomena of diffusion and/or fusion of the copper and silver. Lastly, such a process may be easily transposed to the industrial scale.

Step i)

Step i) makes it possible to form a homogeneous mixture of copper and silver, while avoiding metal diffusion phenomena.

Step i) may be carried out by dispersing a powder of micrometric copper particles and a powder of micrometric or submicrometric silver particles in said non-solvent medium.

The non-solvent medium is a liquid which does not solubilize the copper and silver grains. It notably makes it possible to form a suspension.

The non-solvent medium may be chosen from alcohols, water, ketones such as acetone, and a mixture thereof.

As examples of alcohols, mention may be made of ethanol.

In particular, step i) can be carried out according to the following substeps:

i-a) optionally dispersing a powder of micrometric copper particles in a non-solvent medium S₁,

i-b) dispersing a powder of micrometric or submicrometric silver particles in a non-solvent medium S₂, and

i-c) mixing the powder of micrometric copper particles or the dispersion of powder of micrometric copper particles from substep i-a), with the dispersion of powder of micrometric or submicrometric silver particles from substep i-b), notably with stirring.

The non-solvent media Si and S2 may have the same definition as that given above for the non-solvent medium S.

Preferably, the non-solvent media S1 and S2 are identical.

The non-solvent media S1 and S2 are preferably mutually soluble.

Substep i-a) may be carried out under mechanical, magnetic or ultrasonic stirring.

Substep i-b) may be carried out under mechanical or magnetic stirring, notably in order to avoid the degradation of the micrometric or submicrometric silver particles.

Substep i-c) may be carried out under mechanical, magnetic or ultrasonic stirring.

The micrometric copper particles may have at least one of their dimensions ranging from about 0.5 to 20 μm, preferably from about 0.5 to 10 μm, preferably from about 0.5 to 4 μm, and more preferably from about 0.5 to 1.5 μm.

The micrometric copper particles are preferably spherical micrometric particles.

The silver particles may have at least one of their dimensions ranging from about 0.1 to 150 μm, and preferably from about 0.5 to 70 μm.

The micrometric or submicrometric silver particles may be spherical or filiform.

The spherical micrometric or submicrometric silver particles may have a diameter ranging from about 0.5 to 20 μm, preferably from about 0.5 to 10 μm, preferably from about 0.5 to 4 μm, and more preferably from about 0.5 to 1.5 μm.

According to one embodiment of the invention, the micrometric or submicrometric silver particles are filiform.

In particular they have:

a length (L′_{Ag}), extending along a main direction of elongation,

two dimensions (D′_{Ag1}) and (D′_{Ag2}), referred to as orthogonal dimensions, extending along two transverse directions that are orthogonal to one another and that are orthogonal to said main direction of elongation, said orthogonal dimensions (D′_{Ag1}, D′_{Ag2}) being smaller than said length (L′_{Ag}) and less than or equal to 700 nm, and preferably less than or equal to 500 nm, and

two ratios (F′_{Ag1}) and (F′_{Ag2}), referred to as shape factors, between said length (L′_{Ag1}) and each of the two orthogonal dimensions (D′_{Ag1}) and (D′_{Ag2}), said shape factors (F′_{Ag1}, F′_{Ag2}) being preferably greater than 50.

According to one preferred embodiment, the two orthogonal dimensions (D′_{Ag1}, D′_{Ag2}) of a filiform particle are equivalent or similar and represent the diameter (D′_{Ag}) of its transverse cross-section. Reference is then made to a “stick” or “wire”.

According to another preferred embodiment, a filiform particle is a “tape” in which the two orthogonal dimensions of the particle according to the invention are its width (I′_{Ag}) (first orthogonal dimension) and its thickness (E′_{Ag}) (second orthogonal dimension), the width (I′_{Ag}) being notably much greater than the thickness (E′_{Ag}).

Advantageously, the filiform micrometric or submicrometric silver particles according to the invention are characterized by at least one of the 15 following features:

the two orthogonal dimensions (D′_{Ag1}, D′_{Ag2}) of the filiform particles range from about 50 nm to 400 nm, and preferably from about 100 nm to 300 nm;

the length (L′_{Ag}) ranges from about 1 μm to 150 μm, and preferably from about 10 μm to 70 μm;

the shape factors (F′_{Ag1}, F′_{Ag2}) are greater than or equal to about 75, preferably range from about 100 to 400, more preferably from about 100 to 300, and more preferably are of the order of 200.

Step ii)

Step ii) makes it possible to evaporate the non-solvent media.

It may be carried out using a rotary evaporator, notably under vacuum.

The drying temperature preferably ranges from about 70 to 100° C., and is more preferably of the order of 80° C.

According to one preferred embodiment of the invention, the composite powder comprises at most about 2% by volume of silver particles, preferentially at most about 1.5% by volume of silver particles, and even more preferentially at most about 1% by volume of silver particles, relative to the total volume of said powder.

Step ii′)

The process may further comprise a step ii′) of reducing the dried composite powder from step ii), in the presence of dihydrogen. This step ii′) may make it possible to eliminate the copper oxide layer which may form on the surface of the copper particles.

Step ii′) may be carried out at a temperature T1 of from about 100 to 300° C., preferably from about 110 to 240° C., and more preferably from about 120 to 160° C.

Step ii′) may be carried out by heating the powder from ambient temperature to the temperature T1 as defined in the invention, at a rate ranging from about 1° C./min to 5° C./min, and more preferably ranging from about 2° C./min to 3° C./min.

Step iii)

In the present invention, the expression “flash sintering” means sintering under uniaxial pressure based on the use of an electric current. Flash sintering is also well known under the term “Spark Plasma Sintering” or SPS.

Step iii) makes it possible to consolidate the powder obtained in the preceding step ii) or ii′), while avoiding the phenomena of diffusion and/or fusion of the copper and/or of the silver.

This step iii) is preferably carried out at a temperature T2 of at most about 550° C., preferentially ranging from about 375 to 525° C., and even more preferentially ranging from about 390 to 450° C. These temperatures make it possible to obtain a composite solid mass having a sufficient residual porosity to be able to be cold drawn in the subsequent steps (e.g. without breakages and/or cracks and/or ruptures).

According to one preferred embodiment of the invention, the sintering is carried out by heating the powder:

from ambient temperature to 350° C. at a rate ranging from about 20° C./min to 30° C./min, and

from 350° C. to the temperature T2 at a rate ranging from about 40° C./min to 60° C./min.

The sintering is preferably carried out under low or high vacuum, or under an argon or nitrogen atmosphere.

The pressure exerted on the composite powder resulting from step ii) or ii′) preferably ranges from 20 to 100 MPa, and even more preferentially from 25 to 35 MPa.

The sintering time varies depending on the temperature. This time generally ranges from about 20 to 30 minutes.

According to one particularly preferred embodiment of the invention, the sintering is carried out under high vacuum, at a pressure of about 25 to 50 MPa, at a maximum temperature of 400 to 500° C., maintained for a time of from 3 to 10 minutes. The total duration of the heat treatment is, in this case, less than 1 h 30 minutes.

The intensity of the pulsed current may range from about 10 to 250 A. The duration of each current pulse is of the order of several milliseconds. This duration preferably ranges from about 2 to 4 ms.

In particular, the composite solid mass obtained at the end of step iii) has a relative density ranging from about 85 to 97%, preferably from about 90 to 95%, and more preferably from about 92 to 96%. Indeed, these density ranges are adapted in order to be able to carry out the next step of drawing, while avoiding the formation of cracks and/or fractures.

At the end of step iii) the composite material may be in the form of a cylinder or a bar, notably having a height or length greater than its diameter. This may thus make it possible to favour the implementation of step iv).

According to one particular embodiment of the invention, the cylinder or bar has a diameter ranging from about 5 to 80 mm, and preferably from about 5 to 40 mm.

Step iii) makes it possible to retain the micrometric size of the copper particles and the micrometric or submicrometric size of the silver particles, and thus to avoid the growth of the metal grains.

The solid composite mass obtained in step iii) is preferably isotropic. In other words, it has no preferential orientation of the grains of copper (respectively of silver), relative to its own macroscopic geometric shape.

Step iv)

The cold-drawing step(s) iv) are preferably carried out at a temperature of at most about 40° C., preferably of at most about 35° C., particularly preferably ranging from about −196° C. to 30° C., and more particularly preferably at ambient temperature.

Ambient temperature corresponds to a temperature ranging from about 18 to 25° C.

The process may comprise several steps iv), notably from about 20 to 80 steps iv), and in particular around forty steps iv).

In one preferred embodiment, the drawing step(s) iv) make it possible to obtain a composite material in the form of a wire, notably having a diameter ranging from about 0.1 to 4 mm, preferably from about 0.2 to 1 mm, and more preferably from about 0.25 to 0.8 mm.

In one preferred embodiment, the drawing step(s) iv) make it possible to obtain a composite material in the form of a wire having a length ranging from about 0.1 to 1000 m, and preferably from about 0.2 to 50 m.

During step iv), the phenomena of rupture and/or cracks and/or breakages are greatly reduced, or even avoided.

The process may further comprise, between steps iii) and iv), a step of cooling the solid composite mass, notably at a cooling rate ranging from about 4° C./min to 7° C./min.

The process in accordance with the second subject results in a material in accordance with the first subject.

The invention also relates to a solid composite material as defined in the first subject of the invention, capable of being obtained according to a process as defined in the second subject of the invention.

The third subject of the invention is the use of a solid composite material in accordance with the first subject of the invention or obtained according to a process in accordance with the second subject of the invention, as an electrical conductor, notably for power and/or telecommunications cables, as a conductor for continuous- or pulsed-field magnets, in the field of intense field installations, or in the field of industrial electromagnetic forming.

Such a solid composite material presents a good compromise between electrical conduction and tensile strength in order to be able to be used in high-voltage cables or overhead electricity transmission lines, notably as an electrical conductor, or in motors, alternators, transformers, or connectors.

Moreover, its good electrical and mechanical properties makes it possible to reduce its diameter, and thus the weight of a conducting wire formed of said solid composite material, while improving or retaining its performance levels. This makes it possible to envisage its use in the aeronautical, space and defence fields; notably in drones, aircraft, missiles, launchers, satellites, probes, or spacecraft; or in terrestrial transport, notably in railway catenary systems.

The solid composite material in accordance with the first subject of the invention may also be used in intense magnetic field installations, notably with non-destructive pulsed magnetic fields of greater than 100 tesla. In particular, the low electrical resistivity of this material may lead, at constant power, to an increase in the duration of the pulse of the pulsed magnetic field and a decrease in the electrical power needed for powering continuous magnets.

Lastly, it may make it possible to increase the service life of electromagnetic forming tools such as pulsed magnets via the integration of wires made of solid composite material in accordance with the first subject of the invention. Specifically, the conducting wires in this field are generally mechanically stressed largely beyond their elastic limit.

Thus, wires made of solid composite material in accordance with the first subject of the invention may be integrated into electromagnetic forming magnet prototypes.

Wires made of solid composite material in accordance with the first subject of the invention may enable the winding of industrial magnets for electromagnetic forming.

### EXAMPLES

The raw materials used in the examples are listed below:

copper powder, 0.5-1.5 μm, Alfa-Aesar,

AgNO₃, Aldrich

ethylene glycol, Aldrich,

polyvinyl/pyrrolidinone PVP, 55000 g/mol, Aldrich.

Unless otherwise indicated, all these raw materials were used as received from the manufacturers.

### Example 1

Preparation of a composite material in accordance with the invention

Silver nanowires were prepared according to a growth process in solution from silver nitrate (AgNO₃), PVP, and ethylene glycol, as described by Sun Y. G. et al.,“Crystalline silver nanowires by soft solution processing”, Nano Letters, 2002. 2(2): p. 165-168, with a PVP/AgNO₃ ratio of 1.53. The silver nanowires obtained have a length ranging from about 30 to 60 μm, and a diameter ranging from about 200 to 300 nm.

A suspension comprising 0.178 g of silver nanowires and 9 ml of ethanol was prepared.

The suspension of silver nanowires was mixed with 15 g of copper powder, then the resulting mixture was homogenized using ultrasound, then evaporated using a rotary evaporator at 80° C. A composite powder PC₁ comprising 1% by volume of silver, relative to the total volume of the powder was thus obtained.

The composite powder was reduced in the presence of dihydrogen for 1 h at 160° C. in order to reduce the copper oxide formed on the surface of the copper particles.

The resulting powder was then sintered by SPS using a device sold under the trade name Dr Sinter 2080®, by the company Syntex Inc.

To do this, the composite powder was placed in a die made of tungsten carbide and cobalt (WC/Co) alloy with an internal diameter of 8 mm, the interior of which was protected by a graphite film. The die was then closed by symmetrical pistons then introduced into the chamber of the SPS machine. The sintering was carried out under vacuum (residual pressure of the chamber<10 Pa) using defined pulsed direct currents over 14 periods of 3.2 ms, including 12 periods of pulses and 2 periods of no pulses. The temperature was controlled using a thermocouple introduced into an orifice (depth of 5 mm) drilled through the outer surface of the die. A temperature of 500° C. was reached in two steps: a ramp of 25° C.min⁻¹ for 13 minutes in order to go from ambient temperature to 350° C., then a ramp of 50° C.min⁻¹ for 3 minutes in order to go from 350° C. to 500° C. This temperature was then maintained for 5 minutes. These temperature ramps were obtained by applying defined pulsed direct currents over 14 periods of 3.2 ms, including 12 periods of pulses and 2 periods of no pulses. A pressure of 25 MPa was reached in 1 minute and maintained for the remainder of the sintering. The die was then cooled within the chamber of the SPS. The composite 25 solid mass MSC_{A} obtained is in the form of a cylinder with a diameter of 8 mm and a length of 33 mm.

The composite solid mass obtained was then drawn at ambient temperature using a tungsten carbide die. After 40 passes, a composite material in the form of a wire FC₁ with a diameter of 0.29 mm and a length of 25 m was obtained. No rupture of the wires was observed.

The composite powders and the composite wires were analysed by scanning electron microscopy (SEM) using a field-emission gun, sold under the trade name JEOL JSM 6700F by the company JEOL, and operating at 200 kV.

The density of the composite solid masses and of the composite wires was determined by the Archimedes method.

The electrical resistivity of the composite wires was determined at 77K (liquid nitrogen) using the four-point method with a maximum current of 100 mA in order to avoid heating of the wires.

The tensile strength was measured using a device sold under the trade name INSTRON 1195 by the company INSTRON, at 77K (liquid nitrogen) and at 293K on composite wires with a length of 170 mm. The specific tensions encountered were measured with a force sensor (1000 N or 250 N; 1.6×10⁻⁵ m.s⁻¹).

By way of comparison, a process identical to the one as described above (identical operating conditions) was used, replacing the volume proportion of silver which was about 1% by volume, with an amount by volume of about 10% by volume. A composite powder PCA comprising 10% by volume of silver, relative to the total volume of the powder was thus obtained at the end of step i). The composite powder PCA is not part of the invention. A composite solid mass MSCA and a composite wire FCA which are not part of the invention, were also obtained.

The density of the composite solid masses MSCI and MSCA is about 94% (±2%).

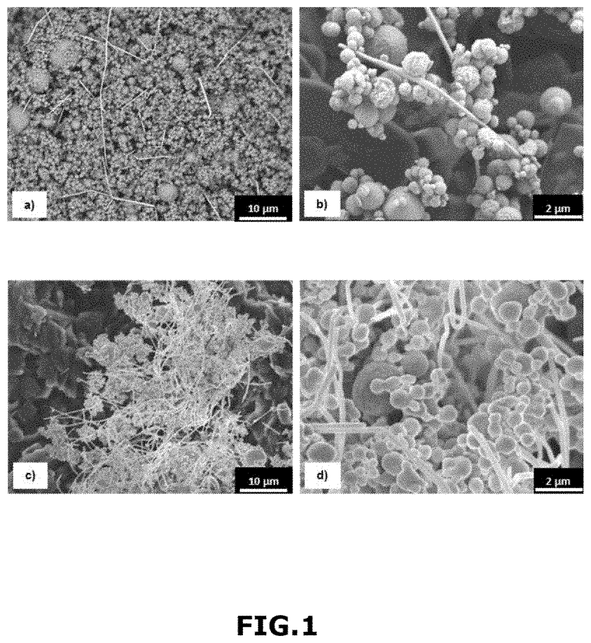

FIG. 1 is an SEM image of the composite powder PC1 in accordance with the invention (cf. FIG. 1a: 10 μm scale, and FIG. 1b: 2 μm scale), and of the composite powder PCA not in accordance with the invention (cf. FIG. 1c: 10 μm scale, and FIG. 1d: 2 μm scale). FIG. 1 shows the uniform dispersion of the silver nanowires within the copper powder, leading to a homogeneous powder. In contrast, the use of a volume amount of silver of about 10% by volume does not make it possible to obtain a homogeneous powder.

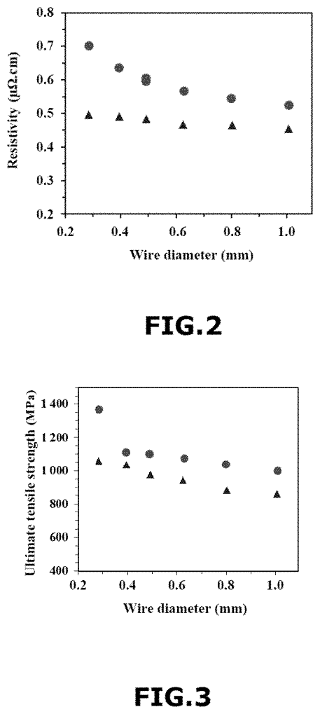

FIG. 2 shows the resistivity (in μΩ.cm) at 77K of a composite material in the form of a wire FC₁ in accordance with the invention (curve with solid triangles) and of a composite material in the form of a wire FC_{A} not in accordance with the invention (curve with solid circles), as a function of their respective diameter (in mm).

FIG. 3 shows the tensile strength (in MPa) at 77K of a composite material in the form of a wire FC₁ in accordance with the invention (curve with solid triangles) and of a composite material in the form of a wire FC_{A} not in accordance with the invention (curve with solid circles), as a function of their respective diameter (in mm).

The tensile strength at 77K of a composite wire in accordance with the invention is two times greater than that of a pure copper wire at equivalent diameters, while guaranteeing low electrical resistivity (0.38-0.50 μΩ.cm). These electrical resistivity values are in particular lower than those obtained for alloys or composites from the prior art having a similar tensile strength, but comprising 20 times more silver.

1. Material comprising copper and silver, whrerein said material is a solid composite material and in that it comprises an amount by volume of silver of less than about 5% by volume, relative to the total volume of said material.

2. Material according to claim 1, wherein the copper and silver are in the form of grains having at least one of their dimensions less than or equal to 500 nm.

3. Material according to claim 1, wherein said material has a conductivity of at least 80% IACS.

4. Material according to claim 1, wherein said material has a tensile strength of at least 1 GPa.

5. Material according to claim 1, wherein said material comprises at most 1.5% by volume of silver, relative to the total volume of said material.

6. Material according to any one of the preceding claim1, wherein the copper and the silver represent at least 99.9% by volume, relative to the total volume of said material.

7. Material according to any one of the preceding claim1, characterized in that wherein the silver and the copper are in the form of grains having a filament form.

8. Material according to claim 7, wherein the copper grains have:
a length, extending along a main direction of elongation,
two dimensions and, referred to as orthogonal dimensions, extending along two transverse directions that are orthogonal to one another and that are orthogonal to said main direction of elongation, said orthogonal dimensions being smaller than said length and ranging from 50 to 400 nm, and
two ratios and, referred to as shape factors, between said length and each of the two orthogonal dimensions and, said shape factors being greater than or equal to 75, and the silver grains have:
a length, extending along a main direction of elongation,
two dimensions and, referred to as orthogonal dimensions, extending along two transverse directions that are orthogonal to one another and that are orthogonal to said main direction of elongation, said orthogonal dimensions being smaller than said length and ranging from 50 to 400 nm, and
two ratios and, referred to as shape factors, between said length and each of the two orthogonal dimensions and, said shape factors being greater than or equal to 75.

9. Process for preparing a solid composite material as defined in claim 1, wherein said process comprises at least the following steps:
i) a step of dispersing micrometric copper particles and micrometric or submicrometric silver particles, in a non-solvent medium,
ii) a drying step in order to form a composite powder comprising said copper and silver particles, said powder comprising an amount of less than 5% by volume of silver particles, relative to the total volume of said powder,
iii) a step of flash sintering at a temperature of at most 600° C., in order to obtain a composite solid mass, and
iv) at least one cold-drawing step, in order to shape the composite solid mass from step iii).

10. Process according to claim 9, wherein the non-solvent medium of step i) is chosen from alcohols, water, ketones, and a mixture thereof.

11. Process according to claim 9, wherein the micrometric copper particles have at least one of their dimensions ranging from 0.5 to 20

12. Process according to any one of claim 9, wherein the micrometric or submicrometric silver particles are filiform particles having:
a length, extending along a main direction of elongation,
two dimensions and, referred to as orthogonal dimensions, extending along two transverse directions that are orthogonal to one another and that are orthogonal to said main direction of elongation, said orthogonal dimensions being smaller than said length, and
two ratios and, referred to as shape factors, between said length and each of the two orthogonal dimensions and, and being characterized by at least one of the following features:
the two orthogonal dimensions, of the filiform particles range from 50 nm to 400 nm;
the length ranges from 1 μm to 150 μm;
the shape factors are greater than or equal to 75.

13. Process according to claim 9, wherein step iii) is carried out at a temperature ranging from 375° C. to 525° C.

14. Process according to claim 9, wherein the composite solid mass obtained at the end of step iii) has a relative density ranging from 85% to 97%.

15. Process according to claim 9, wherein said process further comprises a step ii′) of reducing the dried composite powder from step ii), in the presence of dihydrogen.

16. An electrical conductor, as a conductor for continuous- or pulsed-field magnets, in the field of intense field installations, or in the field of industrial electromagnetic forming, wherein said electrical conductor includes a composite material of claim 1.
